(19) United States
(12) Patent Application Publication
(10) Pub. No.: US 2021/0221299 A1
(43) Pub. Date: Jul. 22, 2021

(54) QUICK CONNECT ATTACHMENT OR DETACHMENT OF AN ITEM TO OR FROM A VEHICLE

(71) Applicant: MLJMJ Holding Company, LLC, Provo, UT (US)

(72) Inventor: Mark L. Layton, Orem, UT (US)

(21) Appl. No.: 16/746,076

(22) Filed: Jan. 17, 2020

(51) Int. Cl. B60R 11/00; G09F 17/00

(52) U.S. Cl. CPC B60R 11/00; G09F 17/00; G09F 2017/0075; B60R 2011/0066; B60R 2011/004; B60R 2011/0078; G09F 2017/0083

(57) ABSTRACT

A quick connect attachment includes an adapter and a quick connect fitting. The adapter includes a first end with threads of a first type and a second end with threads of a second type. Thus, the adapter may convert threads of the first type on a first item to threads of a second type on a first member of the quick connect fitting. The first member of the quick connect fitting and a second member of the quick connect fitting on a second item may enable attachment of the first item to a second item.

### TECHNICAL FIELD

This disclosure relates generally to adapters enable quick connect attachment of an item to a vehicle or detachment of the item from the vehicle. More particularly, this disclosure relates to an adapter for coupling a threaded member of a flag support to a differently threaded member on an off-road or off-highway vehicle; i.e., thread conversion.

### BACKGROUND OF RELATED ART

Most states require that an off-road or off-highway vehicle, such as such as an ATV (all-terrain vehicle), UTV (utility task vehicle), “quad” (four passenger vehicle) or six passenger vehicle, or an off-road motorcycle (collectively, “off-highway vehicle,” or “OHV”) to display a flag which is a bright color, such as red or orange, for safety reasons. For example, in the state of Utah, a red or orange safety flag (called a “whip flag”) must be attached to an OHV when riding in sand dune areas. The whip flag must be at least 6 inches by 12 inches in size, must be at least eight feet off the ground and must be firmly secured to the OHV.

In transporting the OHV to and from a recreational area, it is desirable to remove the whip flag because of its length and, thus, the height to which it extends, and to protect the whip flag from wind damage in transport. Typically, the base of a whip flag is formed in a machine threaded male piece that is attached to a matching female receptacle on the OHV by laboriously threading the male piece into the matching female receptacle, often by using an appropriate wrench. The attachment and detachment of a whip flag is typically difficult and time consuming.

A wide variety of flag supports have been developed to connect flags to vehicles, such as OHVs. An example of such a support is shown in U.S. Pat. No. 8,616,145, in which a flag pole is secured to an OHV by snapping a clamp on an end of the flag pole to a tubular section of the OHV. Another example is shown in U.S. Pat. No. 8,430,052, in which a mounting clip secured to a vehicle and a base that receives an end of a flag pole are rotatably attached to each other. Another flag mounting device is shown in U.S. Pat. No. 9,087,462, in which a body of a flag holder is made to conform to a support tube of a vehicle and fastening members velcro straps enable the flag holder to be quickly and easily secured to and detached from the support tube.

Other devices are designed to be mounted to panels of an OHV through which a bolt hole may be punched or drilled. One such device is shown in U.S. Pat. No. 7,017,511, in which a flag holder mounts on a panel using a threaded retaining fastener secured to a threaded hollow retainer bolt.

Many existing apparatuses do not securely attach flag poles to OHVs. When they do, it is often difficult to remove a flag pole from the existing apparatus, which typically happens when the OHV is loaded onto a trailer for transport.

### SUMMARY

A quick connect attachment according to this disclosure may enable a removable item, or a first item, such as a flag, to be simply and quickly secured to and/or removed from another item, or second item, such as an OHV. The quick connect system may firmly secure the removable item and the other item together, while enabling the removable item to be simply and readily uncoupled from the other item.

In various embodiments, the quick connect system may comprise an adapter and a quick connect fitting. The adapter may include a first end with threads of a first type and a second end with threads of a second type. The threads of the first type and the threads of the second type may differ from each other. As an example, the threads of the first type may comprise pipe threads, while the threads of the second type may comprise machine threads. As another example, the threads of the first type may have a first pitch, while the threads of the second type may have a second pitch. As yet another example, the threads of the first type may have a first diameter, while the threads of the second type may have a second diameter. In a further example, either the threads of the first type or the threads of the second type may comprise external threads on a male member, while threads of the other of the first type and the second type may comprise internal threads in an opening of a female member. By including different types of threads, the adapter may provide for thread conversion between a first type of threads of the removable item and another, second type of threads of a member of a quick connect fitting.

The quick connect fitting may include a first member securable to a removable item, such as a flagpole, and a second member securable to another item, such as an OHV. The first member of the quick connect fitting may include a first end with threads of the first type, which may be complementary to the threads of the first end of the adapter. The complementary threads may enable the first end of the adapter to be secured to the first end of the first member of the quick connect fitting. The second end of the quick connect fitting may be readily and removably secured to the second member of the quick connect fitting.

The removable item may include threads of the second type, which may complement the threads of the second type of the second end of the adapter. The complementary threads may enable the adapter to be secured to the removable item.

Together, the adapter and the quick connect fitting may enable the removable item to be quickly connected to and disconnected from the other item.

A method for securing a removable item, such as a flag pole, to another item, such as an OHV, may include securing an adapter to the removable item, securing a first member of a quick connect fitting to the adapter, and causing the first member of the quick connect fitting to readily and removably engage a second member of the quick connect fitting, which is secured to (e.g., mounted to, etc.) the other item. The first member of the quick connect fitting may be secured to the adapter with threads of a first type (e.g., pipe threads, etc.). The adapter may be threadingly secured to the removable item with threads of a second type (e.g., machine threads, etc.). Such a method may also include securing (e.g., mounting, etc.) a second member of the quick connect fitting to the other item. Once removal of the removable item from the other item (e.g., removal of the flag pole of a whip flag from an OHV, etc.) is desired, the first member and the second member of the quick connect fitting may be readily disengaged from one another and the removable item may be pulled away from the other item.

Other aspects of the disclosed subject matter, as well as features and advantages of various aspects of the disclosed subject matter, will become apparent to those of ordinary skill in the art through consideration of the ensuing description, the accompanying drawings, and the appended claims.

### BRIEF DESCRIPTION OF THE DRAWINGS

In the drawings:

FIG. 1 is a perspective view of an OHV with a safety flag attached thereto, according to an embodiment of the present disclosure;

FIG. 2 is a perspective view of a threaded end of a flag pole of the safety flat shown in in FIG. 1;

FIGS. 3 and 4 are perspective views first and second members of a quick connect device in separated and connected arrangements, respectively;

FIGS. 5 and 6 show perspective close up views of the threaded male and female ends of the adapter shown in FIG. 1;

FIGS. 7A and 7B are perspective views showing a specific embodiment of adapter;

FIG. 7C is a perspective view of another embodiment of adapter, which includes two male ends that are externally threaded;

FIG. 7D is a perspective view of yet another embodiment of adapter, which includes two female ends with openings that are internally threaded;

FIGS. 8 and 9 show the members of the quick connect fitting of FIGS. 3 and 4 secured to an end of a flag pole, such as that depicted by FIG. 2, and an adapter, such as that depicted by FIGS. 5 and 6;

FIG. 10 is a perspective view of member of a quick connect fitting that has been secured to an OHV;

FIG. 11 is a perspective view showing the member of the quick connect fitting shown in FIG. 10 connected to the other member of the quick connect fitting, which is secured to an adapter that is, in turn, secured to a flag pole;

FIGS. 12 and 13 are perspective views of the members of another embodiment of quick connect fitting, with FIG. 12 showing one member of the quick connect fitting secured to a frame of an OHV and FIG. 13 showing the other member of the quick connect fitting;

FIG. 14 is a perspective view showing an embodiment of an adapter connected the member of the quick connect fitting shown in FIG. 13; and

FIG. 15 is a perspective view showing the adapter of FIG. 14 on an end of a flag pole.

### DETAILED DESCRIPTION

In one embodiment of the present disclosure, a quick connect attachment enables a flag pole to be easily secured and securely coupled to an OHV. The quick connect system may include an adapter that may secured to an end of a flag pole to enable the flag pole to be used with a quick connect fitting. More specifically, the adapter may be threadingly secured to the end of the flag pole to enable the flag pole to be used with a quick connect fitting that includes a different, incompatible type of threads. Thus, the adapter converts threading on the end of the flag pole (e.g., machine threads, etc.) to threading of the quick connect fitting (e.g., pipe threads, etc.).

Pipe threads are used to provide an effective seal for pipes transporting liquids, gases, steam, and hydraulic fluid. Tapered pipe threads are particularly effective in providing a seal to eliminate leakage of liquids. The diameter of the tapered pipe (NPT) threads is increased over a thread distance, so that as male and female ends of adjacent pipes are screwed together, the male and female threads compress and wedge themselves together. Machine threads are more general in their use than pipe threads. A machine screw thread functions as both a simple machine and also as a fastener. Machine screw threads are used on bolts, set screws, and machine screws and are designed to mate with preformed threads in nuts or tapped holes. The width and height of a machine thread are typically consistent along a length of the machine thread. Typically, machine threads are not compatible with pipe threads because of their differing angles, shapes, and/or thread pitches.

The quick connect (or “QC”) fitting, which may also be referred to as a “quick connect coupler,” a “quick disconnect coupler,” or a “quick release coupler,” may comprise the type of coupling that is normally used to provide a fast, make-or-break connection between fluid transfer lines, whether for air, gas or liquid. Operated by hand, QC fittings replace threaded or flanged connections, enabling connection and disconnection without twisting and without a wrench. When equipped with self-sealing valves, QC fittings will, upon disconnection, automatically contain any fluid in the line.

Use of the QC fitting of a quick connect attachment according to this disclosure does not involve the transmission of fluid. Rather, the QC fitting is used to enable a removable item, or first item, such as a flag pole of a whip flag, to be quickly assembled with and disassembled from another item, or second item, such as an OHV.

Looking at FIG. 1, an OHV 10 is shown with a flag 12 (e.g., a safety flag, or whip flag, etc.) attached by way of a flag pole 14. A quick connect attachment 16 is shown providing a quick connect-disconnect interface between the flag pole 14 and the OHV 10. The quick connect attachment 16 may, therefore, enable the flag 12 to be readily connected to and readily removed from the OHV 10. The quick connect attachment 16 may alternatively releasably secure secure another type of accessory or another device to the OHV 10. For example, the quick connect attachment 16 may releasably secure a banner, a timer, an alarm, or the like to the OHV 10.

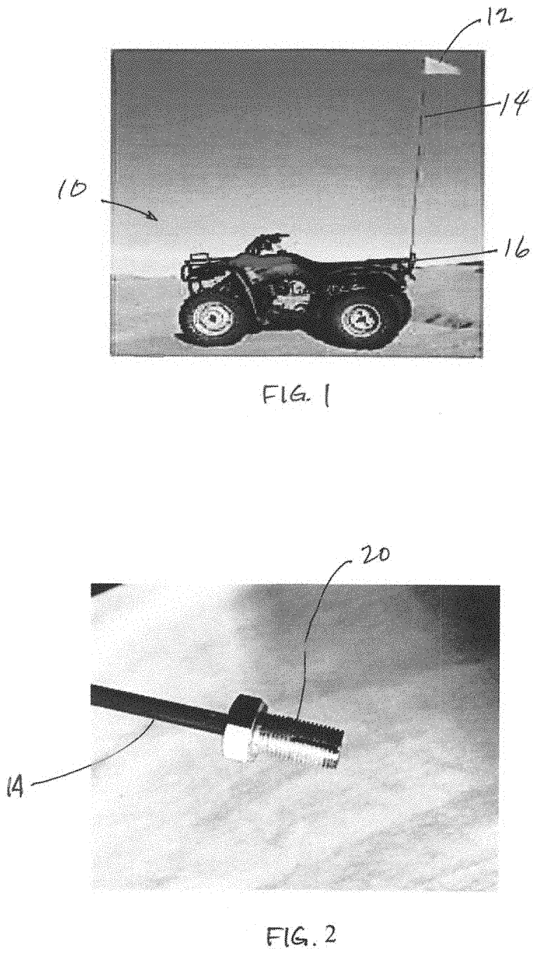

Shown in FIG. 2 is a portion of flag pole 14 with an end 20 that is threaded. The threads on the end 20 of the flag pole 14 may comprise machine threads. The threads on the end 20 of the flag pole 14 may enable the flag pole 14 to be screwed into a female end (not shown in FIG. 2) of an adapter (not shown in FIG. 2) of the quick connect attachment 16 (FIG. 1).

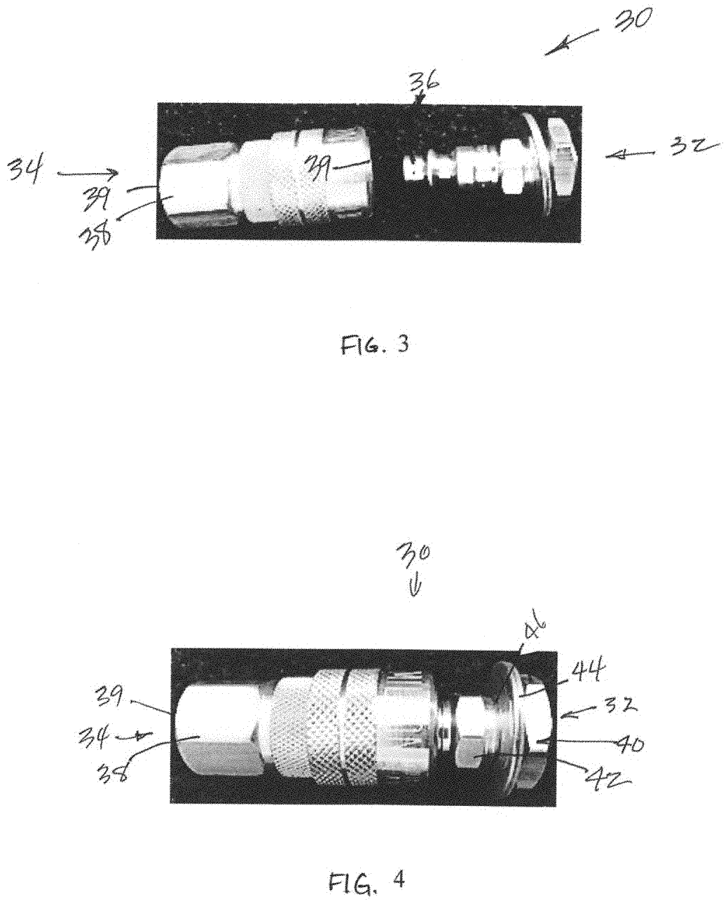

Looking next at FIG. 3, a QC fitting 30 of the quick connect attachment 16 (FIG. 1) is shown. The QC fitting 30 may comprise a quick connect fitting of the type that may be used to secure fluid transfer lines (e.g., air hoses, high pressure hoses, etc.). The QC fitting 30 may include a first member 34 and a second member 32 that complement each other and that may be readily coupled to and uncoupled from one another. The first member 34 may, as illustrated, comprise a male member. The second member 32 may, as illustrated, comprise a female member. A tip 36 of the second member 32 may have a configuration that enables it to be readily aligned with and inserted into an opening 38 in an end of the first member 34. The opposite end of the first member 34 may include an opening 39, an interior of which may be threaded (e.g., with a pipe thread, etc.).

Referring to FIG. 4, the first member 32 of the QC fitting 10 is shown coupled to, or mated with, the second member 34 of the QC fitting 10. The first member 32 and the second member 34 may be locked into place relative to one another by a conventional quick connect-release mechanism. For example, the second member 34 may include a plurality of circumferentially arranged, spring-loaded balls that extend through a wall of the second member near the opening 38, as well as a spring-loaded slidable element positioned over the spring-loaded balls to force them partially into a receptacle that communicates with the opening to enable the balls to engage a circumferential groove adjacent to the tip 36 of the second member 32 upon introducing the tip 36 into the opening 38 of the first member 34 and that may be slid off of the balls to enable them to release the circumferential groove adjacent to the tip when uncoupling of the first member 34 and the second member 32 of the QC fitting 10 is desired.

FIG. 4 also shows an assembly 40 at the end of second member 32. The assembly includes a nut 42 and washer 44 on a threaded end 46 of the second member 32.

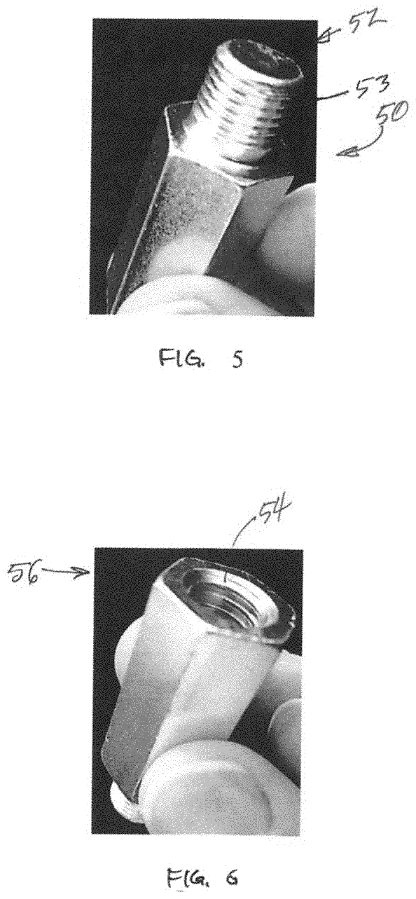

Referring next to FIGS. 5 and 6, an adapter 50 of the quick connect attachment 16 (FIG. 1) is shown. A first end 52 of the illustrated embodiment of the adapter 50 comprises a protruding male member with an exterior surface that is threaded. A second end 56 of the illustrated embodiment of the adapter 50 comprises an opening 54 with an interior surface that is threaded. The threading of the first end 52 may comprise machine threads. The threading of the second end 56 may comprise pipe threads. Thus, the adapter 50 may be understood to convert from the machine threads of a removable item, such as a flag pole of a whip flag, to the pipe threads of another item, such as the first member 34 (FIGS. 2 and 3) of the QC fitting 10 (FIGS. 2 and 3), or from pipe threads to machine threads, depending on which side of the adapter 50 is under consideration. Thus, if the first end 52 of the adapter 50 has pipe threads, then the opening 54 in the second end 56 of the adapter 50 may include machine threads. Conversely, if the first end 52 of the adapter 50 has machine threads, the opening 54 in the second end 56 of the adapter 50 may include pipe threads.

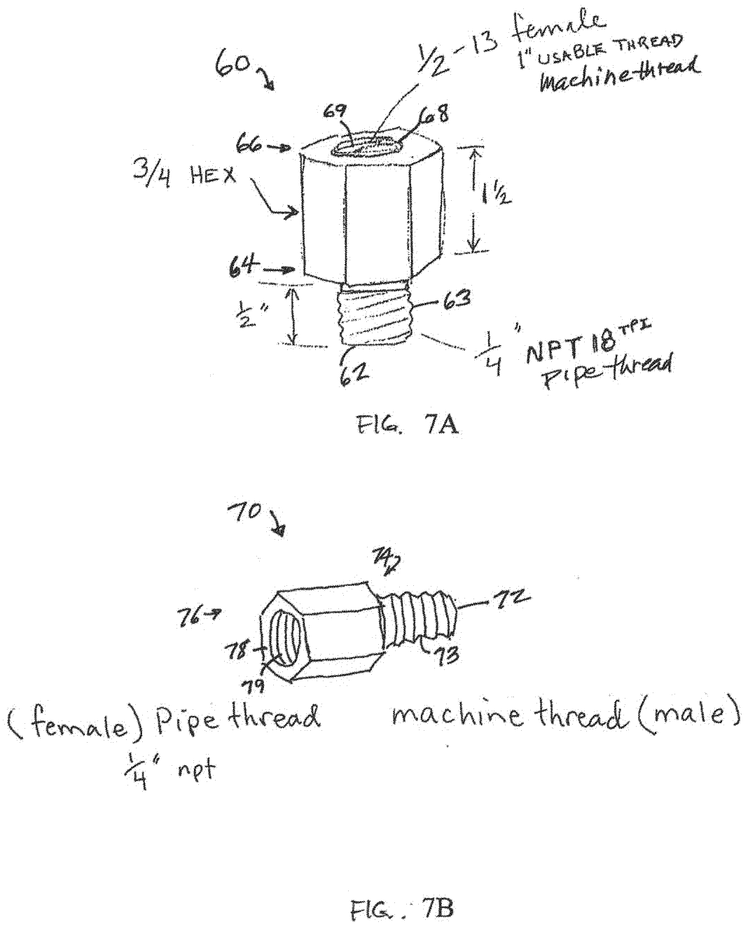

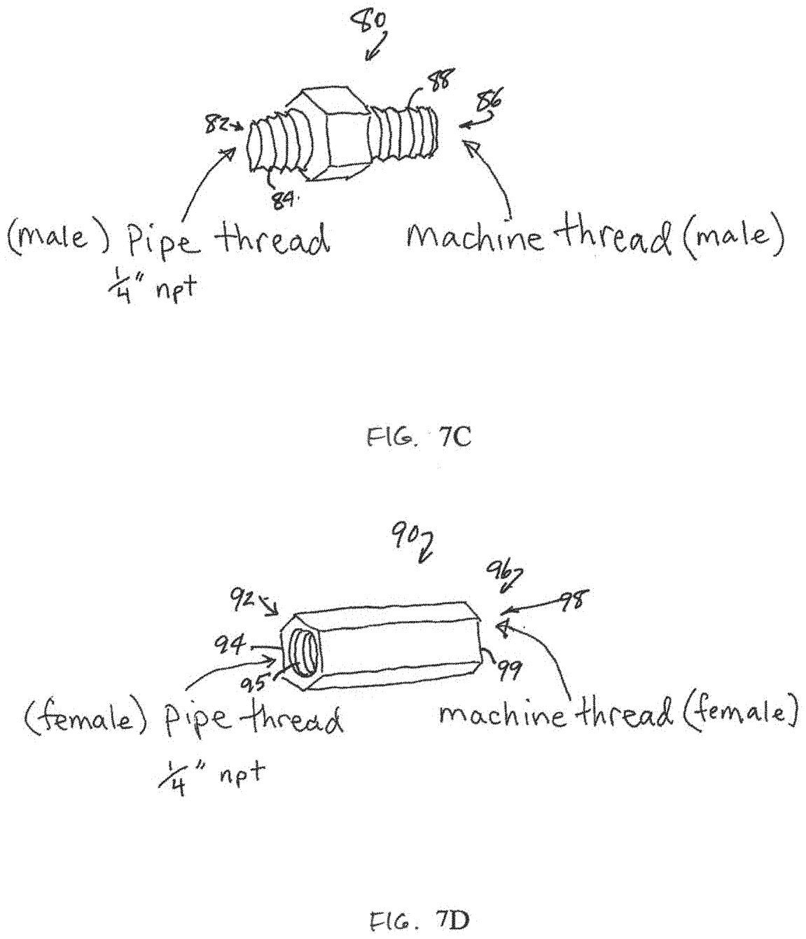

Referencing FIG. 7A, an embodiment of an adapter 60 is shown with a male member 62 having pipe threads 63 at one end 64 and a female member 67 with an opening 68 having machine threads 69 at the other end 66. In a specific embodiment, the female member 67 of the adapter 60 may comprise a ¾ hex member with a length of 1½ inches. The threads 69 of the opening 68 of the female member 67 may comprise machine threads with a ½-13 thread pitch, which may be intended to connect the adapter 60 with machine threads on an exterior surface of an end of a flag pole 14 (FIG. 1) of a flag 12 (FIG. 1) (e.g., a whip flag, etc.), which machine threads may also have a ½-13 thread pitch. The male member 62 of such an adapter 60 may have a length of ½ inch with ¼ NPT pipe threads 63 that may screw into ¼ NPT pipe threads of a female end of a QC fitting 30 (FIGS. 3 and 4). The dimensions and configuration of the embodiment of adapter 60 described in reference to FIG. 7A are only illustrative and do not limit in any manner the scope of this disclosure. An adapter according to this disclosure may also include other types of threads and other thread pitches, including metric and/or American pitched threads.

Looking now at FIG. 7B, an embodiment of an adapter 70 with the opposite configuration of the adapter 60 shown in FIG. 7A is depicted. The adapter 70 includes a male member 72 at one end 74, with machine threads 73 on an exterior surface of the male member 72. A female member 77 is located at another end 76 of the adapter 70, and includes an opening 78 that defines an interior surface with pipe threads 79.

Additional embodiments of adapters 80 and 90 are shown in FIGS. 7C and 7D, respectively. Both ends of the adapter shown in FIG. 7C comprise male members with outer surfaces that include threads of different types. More specifically, a first end 82 of the adapter 80 includes an outer surface with pipe threads 84, while a second end 86 of the adapter includes an outer surface with machine threads 88. Both ends of the embodiment of adapter 90 illustrated by FIG. 7D comprise female members that have openings with inner surfaces that include threads of different types. For example, the threads 95 of an inner surface of an opening 94 in a first end 92 of the adapter 90 may comprise pipe threads 95, while the threads 99 on an inner surface of the opening 98 in the second end 96 of adapter 90 may comprise machine threads 99.

Referring to FIG. 8, a combined unit 110 is shown having a number of elements, most of which have been separately discussed above, shown in an order in which they may be connected according to an embodiment of the present disclosure. A portion of the flag pole 14 is shown with an end 20 that has threading (e.g., machine threading, etc.) on an exterior surface thereof. An adapter 50 is shown with its second end 56 and the opening 54 therein in proximity with the threaded end 20 of the flag pole 14. Next to the first end 52 of the adapter 50 is the opening of the first member 34 of the QC fitting 30. The quick connect end 38 of the first member 34 is positioned next to the tip 36 of the second member 32 of the QC fitting 30. Next to the threaded end 46 of the second member 32 are the washer 44 and the nut 42.

It should be understood that in some embodiments, an orientation of the adapter 50 may be reversed so that a second end 56 of the adapter 50 may be screw onto a member 32, 34 of the QC fitting 30, while the first end 52 of the adapter 50 may screw into a female end of an item, such as a frame of an OHV, to secure the adapter to that item instead of to the flag pole 14 or another replaceable item.

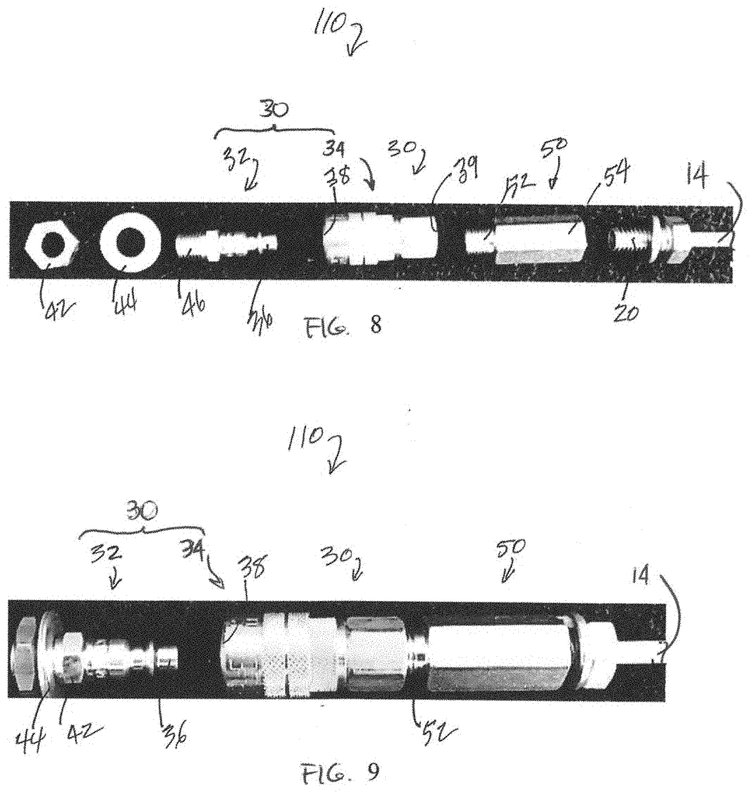

Looking now at FIG. 9, the combined unit is shown 110 in its assembled arrangement with nearly all of the members described above being connected to their adjacent members. The first end 52 of the adapter 50 is secured to the first member 34 of the QC fitting 30, while the second end 56 of the adapter 50 is connected to the end 20 of the flag pole 14. The opening 38 in the first member 34 of the QC fitting 30 is ready to receive the second member of the QC fitting 30 so that the first member 34 may secure the flag pole 14 to the second member 32 and the item, such as an OHV, to which the second member is secured.

As depicted by FIG. 1 and by FIGS. 8 and 9, the quick connect attachment may effectively use an adapter 50 and a QC fitting 30 to attach readily and removable secure a flag 12, such as a whip flag or a safety flag, to any type of OHV 10.

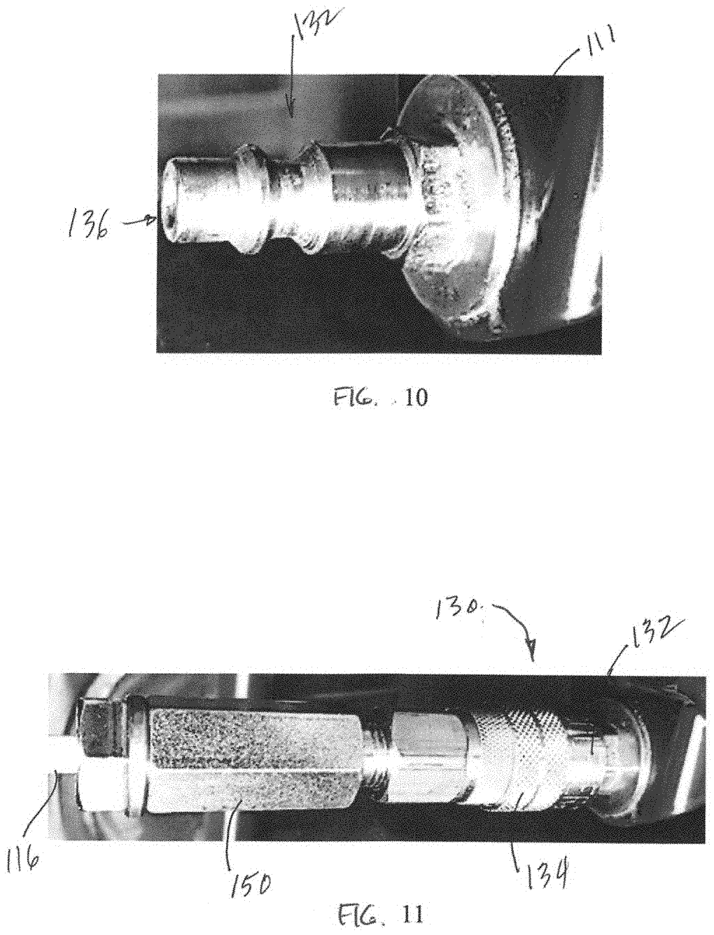

FIGS. 10 and 11 illustrate connection of a safety flag to a frame of an OHV through an adapter 60 of the type shown in FIG. 7A, with the adapter 60 connected to a female member 134 of a QC fitting 130 and the male member 132 of the QC fitting 130 attached to the frame of the OHV. FIG. 10 shows the male member 132 of the QC fitting 130 connected to a frame 111 of an OHV, with a coupling end 136 of the male member 132 protruding from the frame 111. FIG. 11 shows a QC fitting 130 with the male member 132 connected, or coupled, to the female member 134. A pipe-threaded male end of an adapter 150 is screwed into a female member 134 of the QC fitting 130, as described above, with a machine-threaded end of a flag pole 114 screwed into a machine threaded female end of the adapter 150.

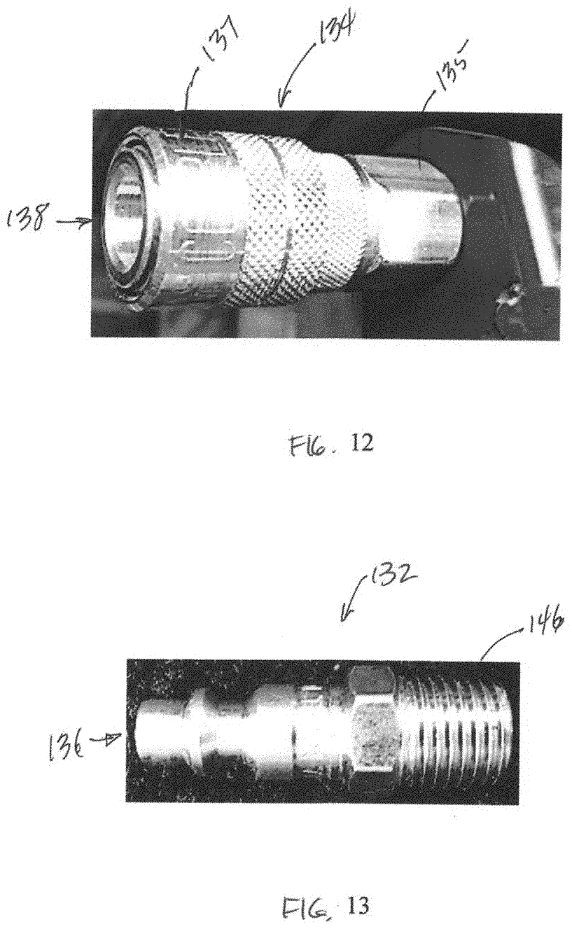

As an alternative to using the embodiment of quick connect attachment shown in FIGS. 10 and 11, FIGS. 12-15 show the use of the embodiment of quick connect attachment that includes the embodiment of adapter 70 shown in FIG. 7D. A female member 134 of a QC fitting 130 may be connected between the frame of an item, such as an OHV, and a male member 132 of the QC fitting 130 may in turn be connected to the adapter 70 which is attached to a removable item, such as a whip flag. As shown in FIG. 12, an end 135 of the female member 134 of the QC fitting 130 may be attached at by conventional means to a frame of an item, such as an OHV, while another end 137 of the female member 134 may protrude from the item. The female member 134 may be oriented in such a way that the opening 138 in the other end 137 of the female member can receive the coupling end 136 of the male member 132 shown in FIG. 13. An opposite end of the male member 132 of the QC fitting 130 includes threads 146 (e.g., pipe threads, etc.) on its exterior surface.

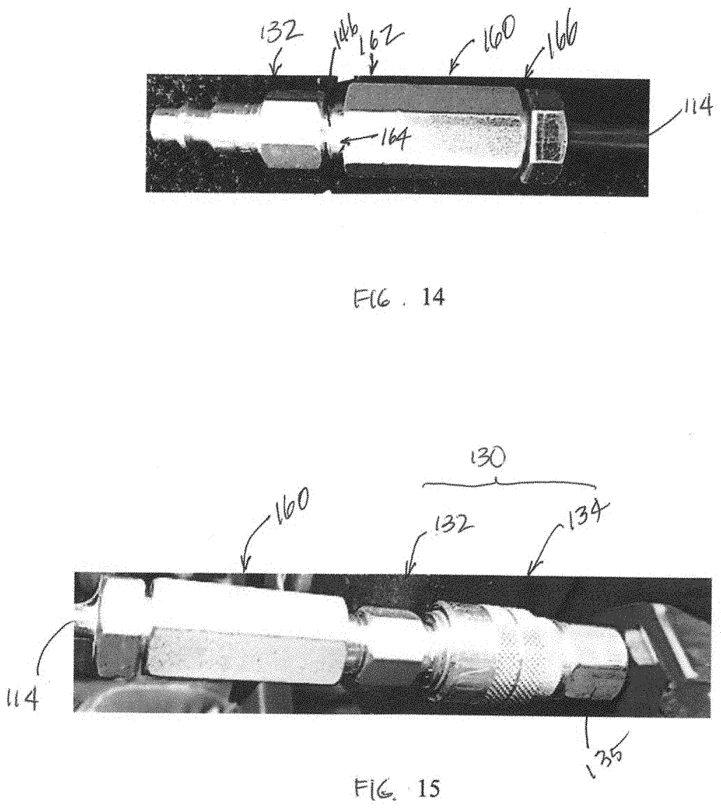

In FIG. 14, an adapter 160 that has two female ends, such as the embodiment shown in FIG. 7D, is shown in an assembled relationship with the male member 132 of the QC fitting 130 (FIG. 11). More specifically, the end of the male member 132 that includes threads 146 (FIG. 13) is screwed into an opening 164 in a first end 162 of the adapter 160, which includes threads (e.g., pipe threads, etc.) (not shown) that complement the threads 146 on the male member 132. An opening in the second end 166 of the adapter 160 also includes threads (e.g., machine threads, etc.) (not shown) that are complementary to the threads (e.g., also machine threads, etc.) on the end of the flag pole 114 or another removable item. In FIG. 15, the adapter 160 is shown connected between the male member 132 of the QC fitting 130 and the flag pole 114 or other removable item. Again, the female member 134 of the QC fitting 130 is secured to the frame of the OHV or other item.

Alternatively, the first member 134 of the QC fitting 130 may be secured directly to the removable item, while the second member 132 of the QC fitting 130 may be secured to the adapter 160, which may, in turn, be secured to the other item.

There are many useful and important advantages in the embodiments of the quick connect attachment and its adapter. For example, an OHV may be transported to a recreational area without a safety flag to prevent wear and tear on the safety flag. The safety flag may then be quickly and readily attached to the OHV at the recreational area and, once use of the OHV is complete, the safety flag may be quickly and readily removed from the OHV. When a quick connect attachment according to this disclosure is used, no wrenches or other tools are needed, nor is any special skill needed, to attach and detach the safety flag.

Optionally, the first member 134 and/or the second member 132 of the QC fitting 130 may be indirectly coupled to its corresponding item (e.g., the adapter 160, the releasable item, the other item, etc.). For example, a separate conventional coupling mechanism may attach the first member 134 and/or the second member 132 to its corresponding item. As another example, two or more adapters may be used to enable conversion from threads of a first type to threads of a third, fourth, fifth, etc., type.

The adapter may be used wherever conversion from a thread of a first type (e.g., a pipe thread, etc.) to a thread of a second type (e.g., a machine thread, etc.) is useful or desirable. As an example, a first end of the adapter may include threads of the first type and a second end of the adapter may include threads of the second type. As another example, a first end of the adapter may include threads of the second type and a second end of the adapter may include threads of the first type.

In addition to using the adapter and the quick connect attachment for releasable connection of a removable item, such as an accessory or other device, to an OHV, the quick connect attachment and its adapter may be used for any of variety of other purposes. For example, a quick connect attachment and/or its adapter may be used to connect a removable item to any type of vehicle, such as a golf cart, a bicycle, a carriage, a cart, a car, a truck, or the like. As another example, the quick connect attachment and/or its adapter may be used with any mobile of stationary unit for individual, commercial, governmental, or military use, and for use both indoors and outdoors.

Although the foregoing description provides many specifics, these specifics should not be construed as limiting the scope of the invention recited by any of the appended claims, but merely as providing information pertinent to some specific embodiments that may fall within the scopes of the appended claims. Other embodiments may also lie within the scopes of the appended claims. Features from different embodiments may be employed in combination. All additions to, deletions from, and modifications of the disclosed subject matter that fall within the scopes of the claims may be embraced by the claims.

What is claimed:

1. An apparatus for securing a removable item to a vehicle, comprising:
an adapter including:
a first end with threads of a first type; and
a second end with threads of a second type;
a quick connect fitting including a first member with:
a first end with threads of the first type that complement the threads of the first type of the first end of the adapter; and
a second end attachable to a second member of the quick connect fitting on the vehicle; and
the removable item, including:
an end with threads of the second type that complement the threads of the second type of the second end of the adapter, the quick connect fitting enabling the removable item to be quickly connected to and disconnected from the vehicle.

2. The apparatus of claim 1, wherein:
the first end of the adapter comprises a male member with the threads of the first type comprising at least one external thread on an exterior of the male member; and
the second end of the adapter comprises a female opening with threads of the second type comprising at least one internal thread within an interior of the female opening.

3. The apparatus of claim 1, wherein:
the first end of the adapter comprises a male member with the threads of the first type comprising at least one external thread on an exterior of the male member; and
the second end of the adapter comprises a male member with the threads of the second type comprising at least one external thread on an exterior of the male member.

4. The apparatus of claim 1, wherein:
the first end of the adapter comprises a female member with the threads of the first type comprising at least one internal thread on an interior surface of the female member; and
the second end of the adapter comprises a female member with the threads of the second type comprising at least one internal thread on an interior surface of the female member.

5. The apparatus of claim 1, wherein the threads of the first type comprise machine threads.

6. The apparatus of claim 1, wherein the threads of the second type comprise pipe threads.

7. The apparatus of claim 1, wherein the quick connect fitting comprises a male member with a connector for attaching to the vehicle.

8. The apparatus of claim 7, wherein the quick connect fitting further comprises a female member with a first end that quickly couples to and/or uncouples from the male member of the quick connect fitting.

9. The apparatus of claim 7, wherein the female member of the quick connect fitting includes the threads of the first type that complement the threads of the first type that complement the threads of the first type on the first end of the adapter.

10. The apparatus of claim 1, wherein the removable item comprises a flag pole.

11. A method for securing a removable item to a vehicle, comprising:
securing an adapter to a first member of a quick connect fitting by causing threads of a first type on a first end of the adapter to engage complementary threads of the first type of a first end of the first member of the quick connect fitting;
securing the adapter to the removable item by causing threads of a second type on a second end of the adapter to engage complementary threads of the second type of an end of the removable item; and
removably securing the first end of the first member of the quick connect fitting to a second member of the quick connect fitting on the vehicle, with at least one of the first member of the quick connect fitting and the second member of the quick connect fitting able to readily disengage and be disconnected from the other of the first member and the second member.

12. The method of claim 11, wherein securing the adapter to the quick connect fitting comprises introducing a male member of the first end of the adapter into a female opening in the first end of the first member of the quick connect fitting.

13. The method of claim 11, wherein securing the adapter to the quick connect fitting comprises introducing a male member of the first end of the first member of the quick connect fitting into a female opening in the first end of the adapter.

14. The method of claim 11, wherein securing the adapter to the removable item comprises introducing a male member of the end of the removable item into a female opening in the second end of the adapter.

15. The method of claim 11, wherein securing the adapter to the removable item comprises introducing a male member of the first end of the adapter into a female opening in the end of the removable item.

16. The method of claim 11, wherein securing the adapter to the removable item comprises securing the adapter to a flag pole.

17. The method of claim 11, wherein securing the adapter to the first member of the quick connect fitting comprises securing the first end of the adapter to the first end of the first member of the quick connect fitting with complementary machine threads.

18. The method of claim 11, wherein securing the adapter to the removable item comprises securing the second end of the adapter to the end of the removable item with pipe threads.

19. The method of claim 11, further comprising:
securing the second member of the quick connect fitting to the vehicle.

20. An apparatus for securing a first unit to a second unit, comprising:
an adapter including:
a first end with threads of a first type; and
a second end with threads of a second type;
a quick connect fitting including a first member with:
a first end with threads of the first type that complement the threads of the first type of the first end of the adapter; and
a second end attachable to a second member of the quick connect fitting securable to the second unit; and
the first unit, including:
an end with threads of the second type that complement the threads of the second type of the second end of the adapter, the quick connect fitting enabling the removable first unit to be quickly connected to and disconnected from the second unit.
